(19) United States
(12) Patent Application Publication
(10) Pub. No.: US 2008/0077421 A1
(43) Pub. Date: Mar. 27, 2008

(54) Policy management program, policy management apparatus and policy management method

(75) Inventors: Noriyuki Kobayashi, Kawasaki (JP); Jun Arima, Kawasaki (JP); Takanori Ugai, Kawasaki (JP); Kouji Aoyama, Kawasaki (JP)

Correspondence Address: Patrick G. Burns;GREER, BURNS & CRAIN, LTD., Suite 2500, 300 South Wacker Dr., Chicago, IL, 60606, US

(73) Assignee: FUJITSU LIMITED

(21) Appl. No.: 11/650,220

(22) Filed: Jan. 4, 2007

(30) Foreign Application Priority Data
Sep. 25, 2006 (JP) 2006-258842

(51) Int. Cl. G06Q 10/00

(52) U.S. Cl. 705/1

(57) ABSTRACT

A policy management program, a policy management apparatus and a policy management method can evaluate policies. A policy management program causes a computer to manage the policies in a project by causing the computer to execute a policy registration step that registers policy information including the contents of policies, a first evaluation step that acquires case information satisfying the predetermined first requirement from the case information including the contents of the utilized policies registered in advance and computationally determines an evaluation value for each of the policies registered in the policy registration step according to the case information and a display step that displays the policy information of the one or more than one policies showing an evaluation value satisfying the predetermined second requirement as computed in the first evaluation step.

### BACKGROUND OF THE INVENTION

1. Field of the Invention

The present invention relates to a policy management program, a policy management apparatus and a policy management method for managing the policy or policies of a project.

2. Description of the Related Art

The KPT (keep/problem/try) method is popularly being used, among others, as a method of managing the problems and the policies (solutions) in an activity.

Profile data retrieving apparatus for retrieving similar case data and also retrieving profile data that can be used as recommended candidate date are known as prior art relating to the present invention (see, for example, Patent Document 1: Jpn. Pat. Appln. Laid-Open Publication No. 2004-21729).

However, when the number of policies is increased for a known policy management method, the user has no idea about the priorities of the policies and hence cannot fined out which one is to be started first. Additionally, an important policy may be buried in a large number of policies.

### SUMMARY OF THE INVENTION

The present invention is for solving such a problem and hence it is the object of the present invention to provide a policy management program, a policy management apparatus and a policy management method that can evaluate policies.

In an aspect of the present invention, the above object is achieved by providing a policy management program that causes a computer to manage the policies in a project by causing the computer to execute: a policy registration step that registers policy information including the content of policies; a first evaluation step that acquires case information satisfying the predetermined first requirement from the case information including the contents of the utilized policies registered in advance and computationally determines an evaluation value for each of the policies registered in the policy registration step according to the case information; and a display step that displays the policy information of the one or more than one policies showing an evaluation value satisfying the predetermined second requirement as computed in the first evaluation step.

In another aspect of the present invention, there is provided a policy management apparatus that manages the policies in a project, the apparatus comprising: a policy registration section that registers policy information including the content of policies; a first evaluation section that acquires case information satisfying the predetermined first requirement from the case information including the contents of the utilized policies registered in advance and computationally determines an evaluation value for each of the policies registered by the policy registration section according to the case information; and a display section that displays the policy information of the one or more than one policies showing an evaluation value satisfying the predetermined second requirement as computed by the first evaluation section.

In still another aspect of the present invention, there is provided a policy management method that manages the policies in a project, the method comprising: a policy registration step that registers policy information including the content of policies; a first evaluation step that acquires case information satisfying the predetermined first requirement from the case information including the contents of the utilized policies registered in advance and computationally determines an evaluation value for each of the policies registered in the policy registration step according to the case information; and a display step that displays the policy information of the one or more than one policies showing an evaluation value satisfying the predetermined second requirement as computed in the first evaluation step.

Thus, according to the present invention, the user can find out one or more than one important policies.

### BRIEF DESCRIPTION OF THE DRAWINGS

FIG. 1 is a schematic block diagram of an embodiment of policy management apparatus according to the present invention, illustrating the configuration thereof;

FIG. 2 is a flowchart of the operation of the embodiment of policy management apparatus of FIG. 1;

FIG. 3 is a schematic illustration of the contents of the policy DB of the embodiment of FIG. 1, shown as an example;

FIG. 4 is a schematic illustration of the contents of the case DB of the embodiment of FIG. 1, also shown as an example;

FIG. 5 is a schematic illustration of the contents of the user evaluation DB of the embodiment of FIG. 1, also shown as an example;

FIG. 6 is a table illustrating the contents of the project information DB of the embodiment of FIG. 1, also shown as an example;

FIG. 7 is a flowchart of the policy registration process of the embodiment of FIG. 1, showing a specific operation thereof;

FIG. 8 is a flowchart of the similarity evaluation process of the embodiment of FIG. 1, showing a specific example thereof;

FIG. 9 is a flowchart of the similar case search process of the embodiment of FIG. 1, showing a specific example thereof;

FIG. 10 is a flowchart of the user evaluation process of the embodiment of FIG. 1, showing a specific example thereof;

FIG. 11 is a flowchart of the policy display process of the embodiment of FIG. 1, showing a specific example thereof;

FIG. 12 is a flowchart of the user evaluation totalizing process of the embodiment of FIG. 1, showing a specific example thereof;

FIG. 13 is a flowchart of the case registration process of the embodiment of FIG. 1, showing a specific example thereof;

FIG. 14 is a flowchart of the user evaluation points updating process of the embodiment of FIG. 1, showing a specific example thereof; and

FIG. 15 is an illustration of the chart to be used in the user evaluation points updating process of the embodiment of FIG. 1, showing a specific example thereof.

### DETAILED DESCRIPTION OF THE PREFERRED EMBODIMENTS

Now, the present invention will be described in greater detail by referring to the accompanying drawings that illustrate a preferred embodiment of the invention.

Firstly, the configuration of this embodiment of policy management apparatus will be described.

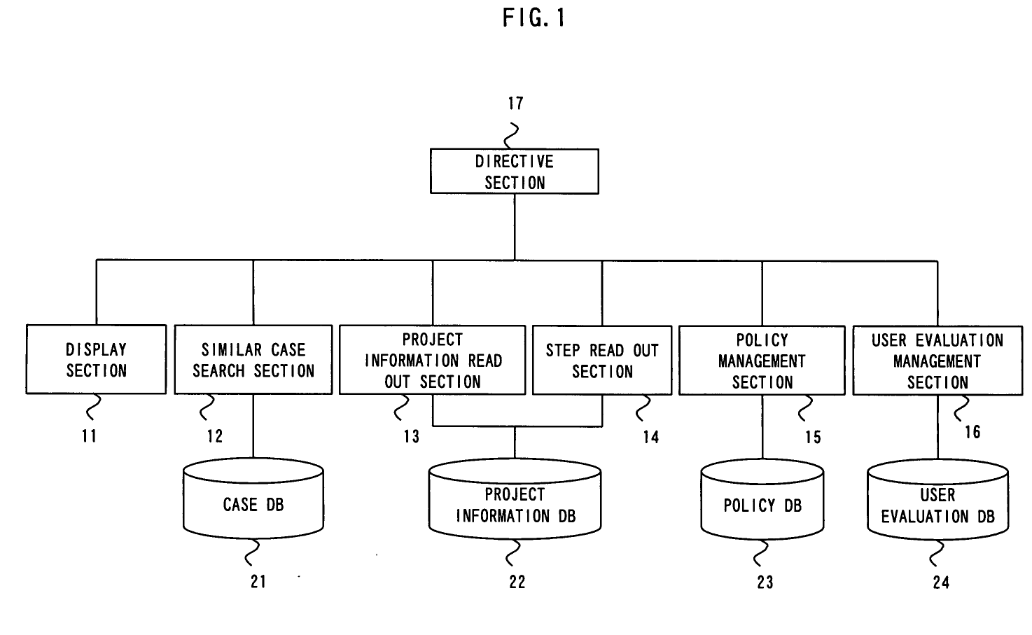

FIG. 1 is a schematic block diagram of the embodiment of policy management apparatus according to the present invention, illustrating the configuration thereof. Referring to FIG. 1, the policy management apparatus comprises a display section 11, a similar case search section 12, a project information read out section 13, a step read out section 14, a policy management section 15, a user evaluation management section 16, a directive section 17, a case DB (data base) 21, a project information DB 22, a policy DB 23 and a user evaluation DB 24. Of these, the display section 11, the similar case search section 12, the project information read out section 13, the step read out section 14, the policy management section 15, the user evaluation management section 16 and the directive section 17 are programs to be executed by the computer of the policy management apparatus. The case DB 21, the project information DB 22, the policy DB 23 and the user evaluation DB 24 are data bases stored in a memory device. The sections of the policy management apparatus may be arranged in different computers.

Now, the operation of the policy management apparatus of this embodiment will be described below.

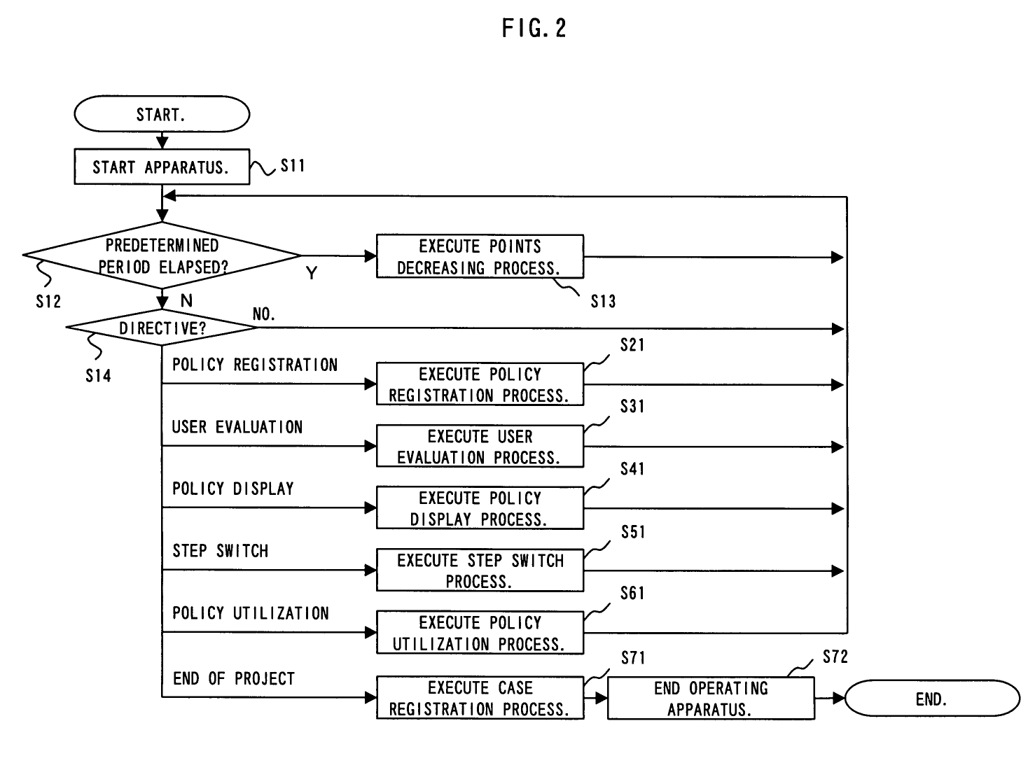

FIG. 2 is a flowchart of the operation of the policy management apparatus of this embodiment. Firstly, the policy management apparatus is started to operate when a project starts (S11). Then, the directive section 17 determines if a predetermined time period has passed or not (S12).

If the predetermined time period has passed (S12, Y), the operation proceeds to the process of S13. If, on the other hand, the predetermined time period has not passed yet (S12, N), the directive section 17 determines the directive from the user (S14). If there is no directive from the user (S14, None), the operation returns to the process of S12. The predetermined time period may typically be 5% of the period of the project.

If the directive from the user is registration of a policy (S14, policy registration), the policy registration section 15 executes a policy registration process for registering a policy (S21) and then returns to the process of S12.

If the directive from the user is evaluation of a policy (S14, user evaluation), the user evaluation management section 16 executes a user evaluation process for registering a user evaluation point that indicates the user's evaluation on a policy (S31) and returns to the process of S12.

If the directive from the user is display of a policy (S14, policy display), the user evaluation management section 16 executes a policy display process for displaying a policy (S41) and returns to the process of S12.

If the directive from the user is switch of a step (S14, step switch), the policy management section 15 executes a step switch process (S51) and returns to the process of S12.

If the directive from the user is utilization of a policy registered in the policy DB 23 (S14, policy utilization), the policy management section 15 executes a policy utilization process (S61) for storing the state when the policy is utilized and returns to the process of S12.

If, finally, the directive from the user is end of the project (S14, project end), the policy management section executes a case registration process (S71) and ends the operation of the policy management apparatus (S72) and hence this flow of operation.

If a predetermined time period has passed in the process of S12 (S12, Y), the user evaluation management section executes a user evaluation point updating process (S13) for updating the user evaluation point and returns to the process of S12.

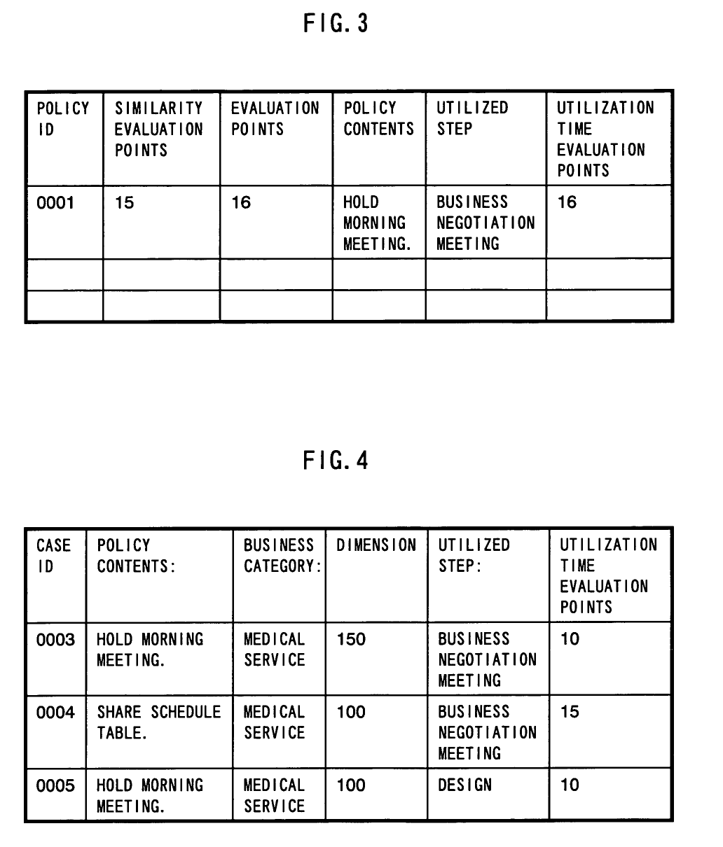

Now, the policy DB 23 will be described below. FIG. 3 is a schematic illustration of the contents of the policy DB of this embodiment, shown as example. The policy DB 23 stores a record of each policy (policy information). The policy DB 23 has fields for policy IDs that are IDs of policies, similarity evaluation points that are evaluation points given according to similar cases, evaluation points (evaluation values) that are the totals of similarity evaluation points and all the users evaluation points, policy contents that describe policies, utilized steps used for utilizing policies and utilization time evaluation points that are evaluation points at the times of utilization of policies. Steps typically include business negotiation meetings, designs, developments, tests and uses.

Now, the case DB 21 will be described below. FIG. 4 is schematic illustration of the contents of the case DB of this embodiment, shown as an example. The case DB 21 stores a record of each case (case information). The case DB 23 has fields for case IDs that are IDs of cases, policy contents of each policy utilized in each case, business categories of projects of cases, dimensions of projects [numbers of people, numbers of months], utilized steps and utilization time evaluation points. Functional service, medical service and circulation service are exemplified as the business categories.

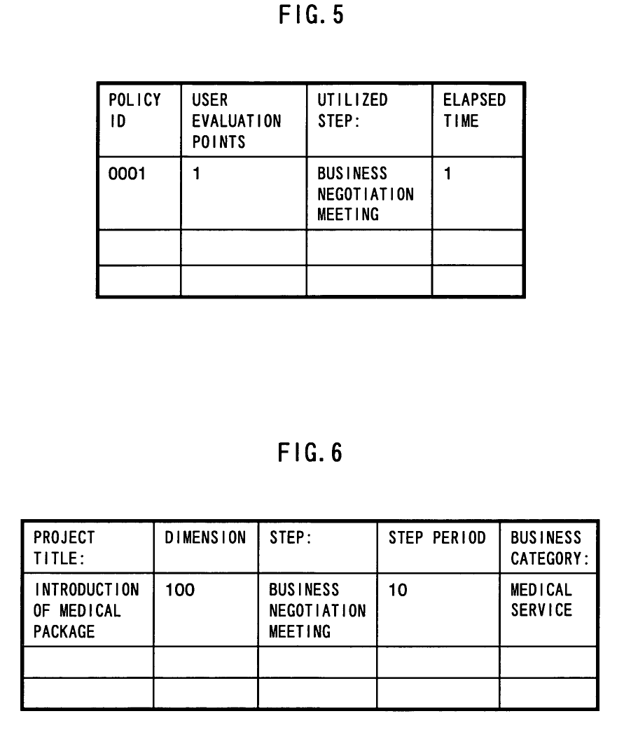

Now, the user evaluation DB 24 will be described below. FIG. 5 is a schematic illustration of the user evaluation DB 24 of this embodiment, shown as an example. The user evaluation DB 24 stores a record of each user evaluation. The user evaluation DB 24 has fields for policy IDs of evaluated policies, user evaluation points (user evaluation values), utilized steps and elapsed times that show the elapsed time since the registration of each record.

Now, the project information DB 22 will be described below. FIG. 6 is a schematic illustration of the project information DB 22 of this embodiment, shown as an example. The project information DB 22 is prepared by means of an external step management tool. The project information DB 22 stores a record of each step in each project. The project information DB has fields for project names, project dimensions, steps, step periods of such steps and industrial categories of projects.

The project information DB 22 indicates the current step of the current project. Now, the policy registration process of S21 will be described below.

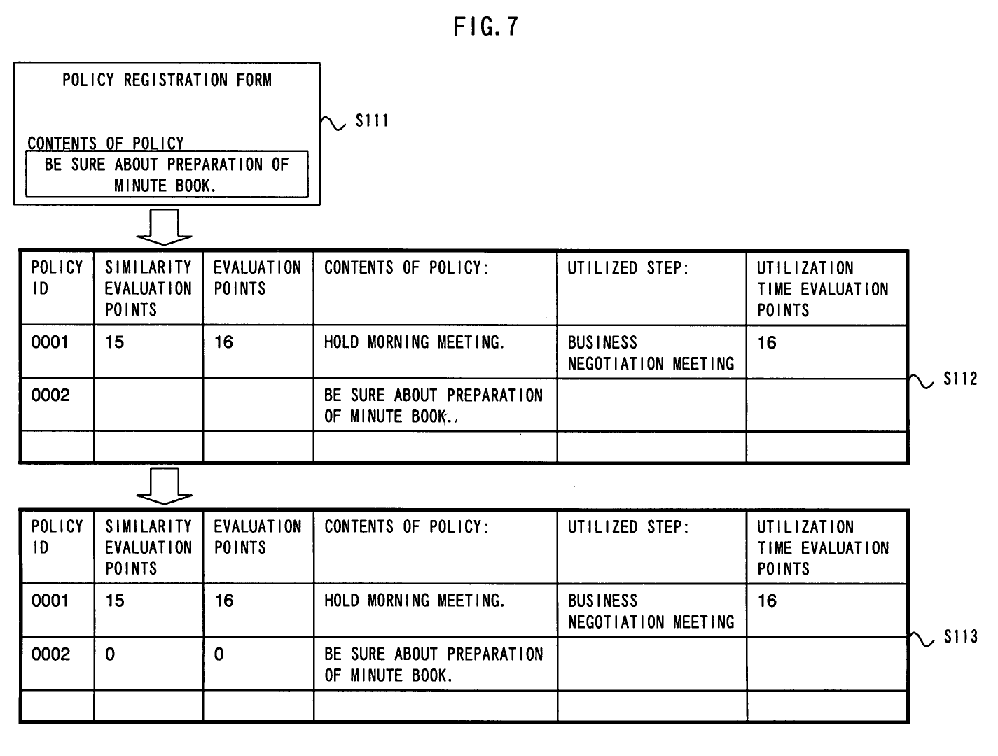

The policy registration process will be described by way of a specific example thereof. FIG. 7 is a flowchart of the policy registration process of this embodiment, sowing a specific example thereof. Firstly, the display section 11 displays the policy registration form and receives an user input (S111). The policy registration form is an image to be used for inputting the contents of a capacity. Then, the policy management section 15 acquires the contents of the input to the policy registration form and registers them as a new record to the policy DB 23 (S112). Thereafter, the policy management section 15 selects the registered policy as object policy and executes a similarity evaluation process for setting similarity evaluation points for the object policy on the basis of similar cases (S113). Then, the policy management section 15 adopts the similarity evaluation points of the new record as evaluation points and ends the flow. Since there is no similar case in this example, the similarity evaluation points of the policy are equal to 0.

Now, the similarity evaluation process pointed out above will be described below.

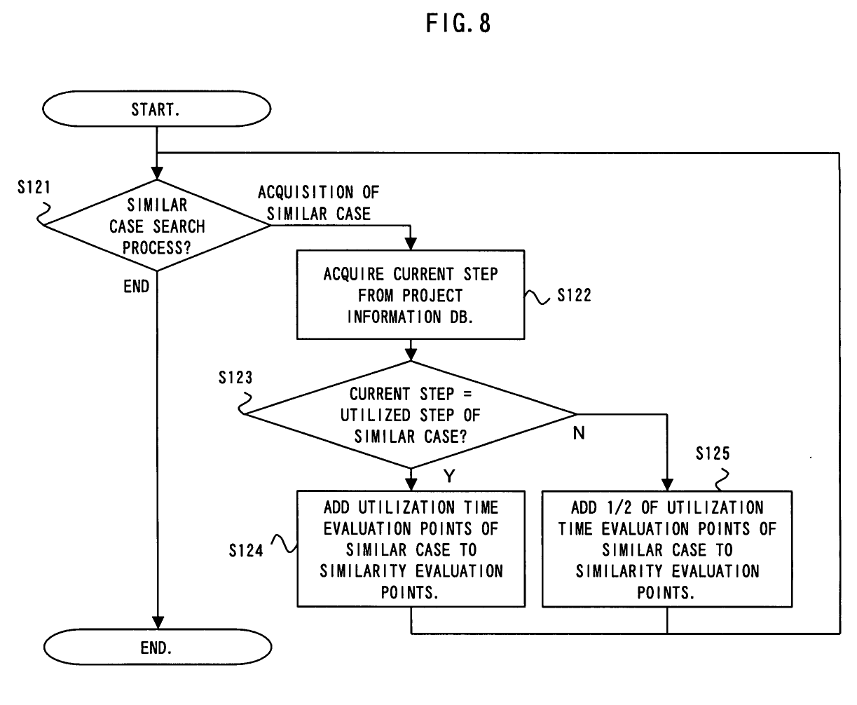

FIG. 8 is a flowchart of the similarity evaluation process of this embodiment, showing a specific example thereof. Firstly, the similar case search section 12 executes a similar case search process for scanning the case DB 21 and extracting one or more than one similar cases of the object policy and, when it gets to the end of the case DB 21 (S121, end) without extracting a similar case, ends the flow. When, on the other hand, the similar case search section 12 acquired one or more than one similar cases of the object policy from the case DB 21 (S121, acquisition of similar case), the step read out section 14 acquires the current step from the project information DB 22 (S122). Then, the policy management section 15 determines if the current step is same as the utilized step of a similar case (S123, Y) and adds the utilization time evaluation points of the similar case to the similarity evaluation points of the object policy (S124) when the two steps are same and then returns to the process of S121, whereas the policy management section 15 adds ½ of the utilization time evaluation points of the similar case to the similarity evaluation points of the object policy (S125) when the two steps are not same (S123, N) and then returns to the process of S121.

Now, the similar case search process in the similarity evaluation process will be described below.

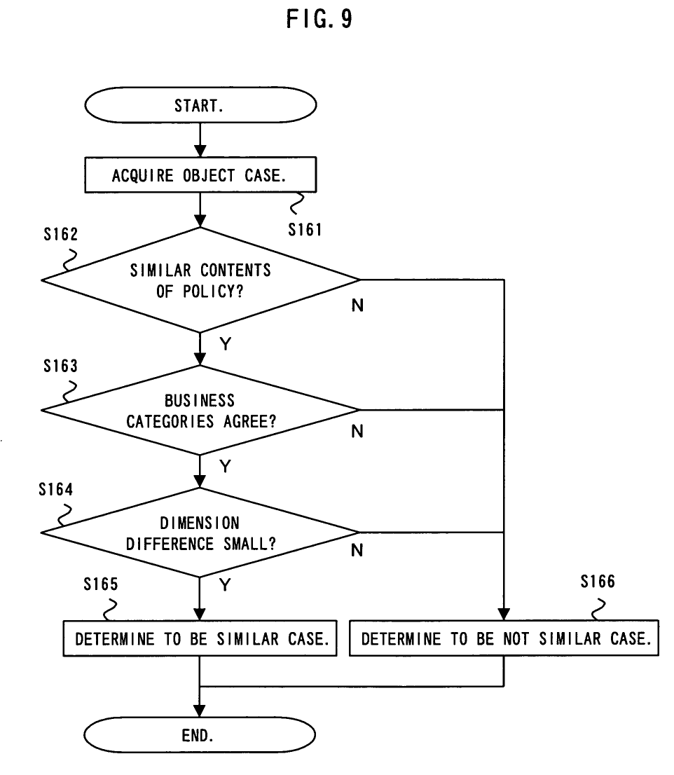

FIG. 9 is a flowchart of the similar case search process of this embodiment, showing a specific example thereof. Firstly, the similar case search section 12 sequentially acquires a record from the case DB 21 as an object case (S161). Then, the similar case search section 12 compares the contents of the object policy and those of the policy of the object case and determines if they are similar relative to each other or not. The similar case search section 12 moves to the process of S166 when they are not similar relative to each other (S162, N), whereas it moves to the next process when they are similar relative to each other (S162, Y). Then, the project information read out section 13 reads out the business of the current project from the project information DB 22 and the similar case search section 12 compares the business category of the current project and that of the object case and determines if they agree with each other or not. The similar case search section 12 moves to the process of S166 when they do not agree with each other (S163, N), whereas it moves to the next process when they agree with each other (S163, Y). Thereafter, the similar case search section 12 compares the current step and the utilized step of the object case and determines if they agree with each other or not. The similar case search section 12 moves to the process of S166 when they do not agree with each other (S164, N), whereas it moves to the next process when they agree with each other (S164, Y).

Then, the similar case search section 12 determines that the object case is a similar case (S165) and ends the flow. Or, the similar case search section 12 determines that the object case is not a similar case (S166) and ends the flow. The processes S162, S163 and S164 may be executed in a sequence different from the above-described one.

With the above-described policy registration process, it is possible to evaluate a new policy by means of the evaluations of similar cases in the past.

While described contents of policies are input to the policy DB 22 and the case DB 21 in the above description, the display section 11 may alternatively be so adapted as to display a multiple-choice for describing the contents of a policy in the policy registration form. Still alternatively, the multiple-choice may be acquired from the contents of policies that are utilized in the past such as the contents of policies stored in the case DB 21. Still alternatively, contents of policies may be stored not as description but as combinations of identifiers that correspond to the multiple-choice and the identifiers may be compared in the similar case search process. Then, both the dispersion of the policy contents input to the policy registration form and the load of the similar case search process will be reduced.

Now, the user evaluation process of S31 will be described below.

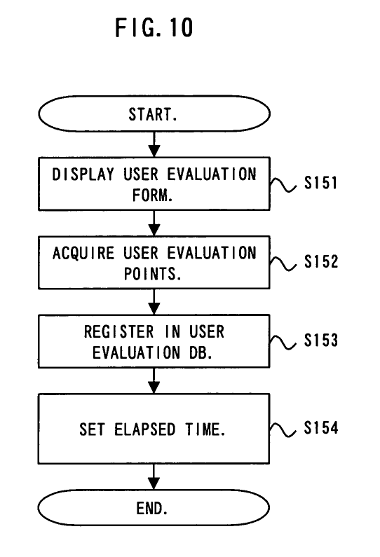

FIG. 10 is a flowchart of the user evaluation process of this embodiment, showing a specific example thereof. Firstly, the display section 11 displays a user evaluation form and receives an input from the user (S151). The user evaluation form is an image to be used for inputting the user evaluation points for the object policy, which may be positive or negative. Then, the user evaluation management section 16 acquires the user evaluation points input to the user evaluation form (S152). Subsequently, the user evaluation management section 16 registers a new record in the user evaluation DB 24 and sets the acquired user evaluation points for the record (S153). Then, the user evaluation management section 16 puts 0 in the record as elapsed time when the user evaluation points are positive, whereas it puts −1 in the record as elapsed time when the user evaluation points are negative (S154) to end the flow.

With the above-described user evaluation process, it is possible to evaluate the current policy as a result of storing the evaluations of other users on policies.

Now, the policy display process of S41 will be described below.

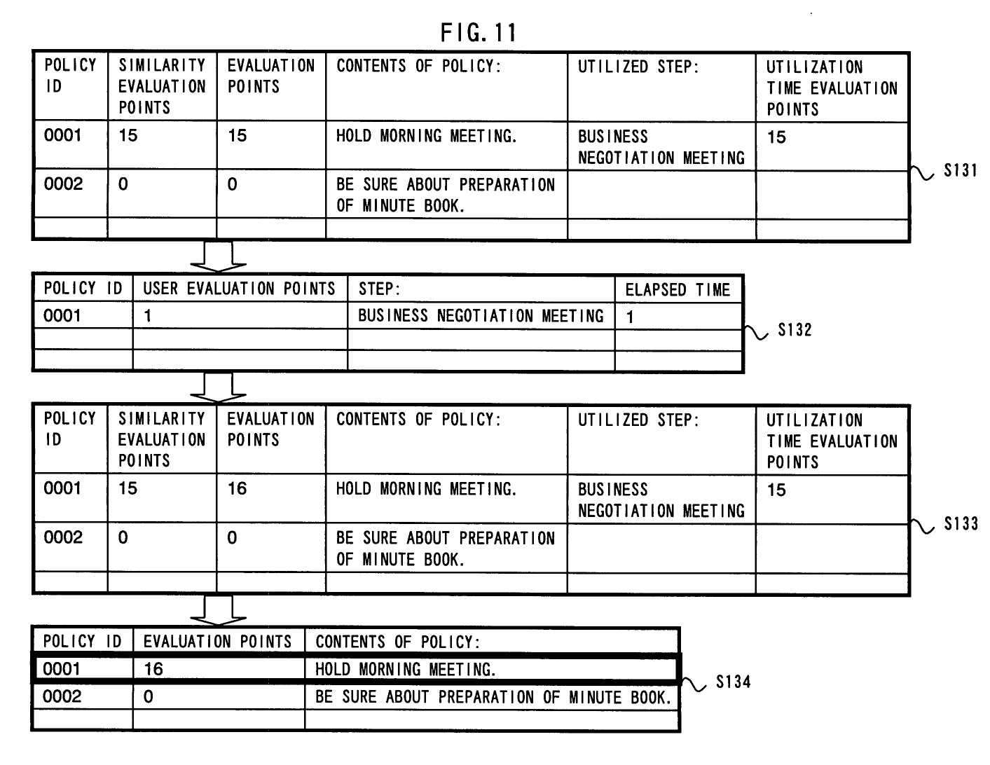

The policy display process will be described below by way of a specific example. FIG. 11 is a flowchart of the policy display process of this embodiment, showing a specific example thereof. Firstly, the policy management section 15 hands over the policy ID of the object policy to the user evaluation management section 16, sequentially selecting the policies in the policy DB 23 as object policies (S131). Subsequently, the user evaluation management section 16 reads out all the user evaluation points that correspond to the policy ID it receives from the user evaluation DB 24 and executes a user evaluation totalizing process of totalizing them to use the total as user evaluation total points. Then, the user evaluation management section 16 hands over the user evaluation total points to the policy management section 15 (S132). Thereafter, the capacity management section 15 adds the similarity evaluation points of the object policy in the policy DB 23 and the user evaluation points it received from the user evaluation management section 16 to produce evaluation points and update the policy DB 23 (S133). Then, the display section 11 displays a list of the policies stored in the policy DB 23 and it also emphatically displays the policies whose evaluation points satisfy predetermined requirements (S134) to end the flow. The predetermined requirements include that the evaluation points are not lower than a predetermined threshold value and that the evaluation points are found within a predetermined level when all the evaluation points are arranged in falling order. Alternatively, the display section 11 may display the contents of the policies whose evaluation points satisfy the predetermined requirements or both the contents of the policies and their evaluation points.

Now, the user evaluation totalizing process in the policy display process will be described below.

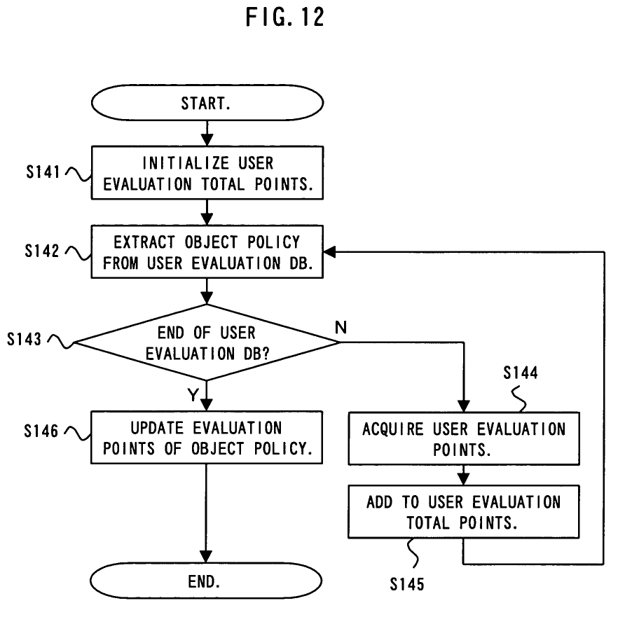

FIG. 12 is a flowchart of the user evaluation totalizing process of this embodiment, showing a specific example thereof. Firstly, the user evaluation management section 16 initializes the user evaluation total points in the temporary region (S141). As the user evaluation management section 16 receives the policy ID of the object policy from the policy management section 15, it scans the user evaluation DB 24 and extracts the record showing the policy ID (S142). Then, the user evaluation management section 16 determines if it gets to the end of the user evaluation DB 24 or not (S143).

If it is determined that the user evaluation management section 16 has not got to the end of the user evaluation DB 24 (S143, N), it acquires the user evaluation points of the extracted record (S144) and adds them to the user evaluation total points in the temporary region (S145) to return to the process of S142. If, on the other hand, it is determined that the user evaluation management section 16 has got to the end of the user evaluation DB 24 (S143, Y), it hands over the user evaluation total points to the policy management section 15, which policy management section 15 then adds the user evaluation total points to the evaluation points of the object policy in the policy DB23 to update the evaluation points of the object policy (S146) and ends the flow.

Thus, with the above-described policy display process, it is possible for the user to know the degree of importance of a policy and reliably realize any important policy because each policy is evaluated by using the evaluation given to it on the basis of similar cases and the user's evaluation and the user is notified of any highly evaluated policy.

Now, the step switch process, which is the process in S51, will be described below.

In the step switch process, the policy management section 15 defines the policy being utilized as object policy, updates the steps for the object policy in the policy DB 23, executes the similarity evaluation process on the updated object policy and updates the similarity evaluation points of the object policy.

With the above-described step switch process, it is possible to evaluate a policy in a manner suitable for a step by switching the step and using the evaluations of the similar cases in the past.

Now, the policy utilization process, which is the process in S61, will be described below.

When a policy registered in the policy DB 23 is utilized, the policy management section 15 selects the utilized policy as object policy and the step read out section 14 acquires the current step from the project information DB 22 and defines it as utilized step of the object policy and also the evaluation points of the object policy as utilization time evaluation points of the object policy.

With the above-described policy utilization process, the state in which a policy is utilized is preserved so that it may be used for evaluating some other policy.

Now, the case registration process, which is the process in S71, will be described below.

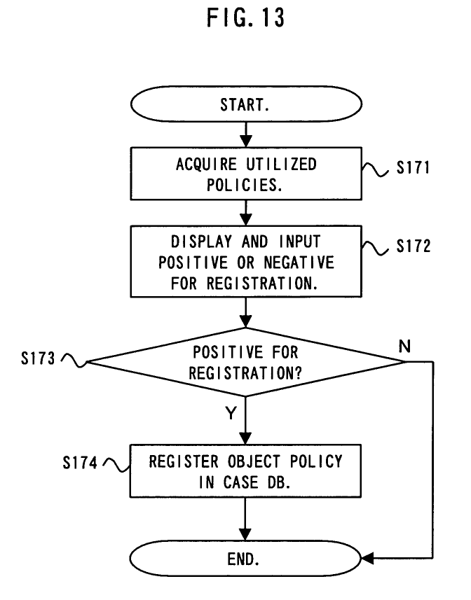

FIG. 13 is a flowchart of the case registration process of this embodiment, showing a specific example thereof. The policy management section 15 acquires a policy utilized in the terminated project from the policy DB 23 and selects it as object policy (S171). The record of the utilized policy contains the utilized steps and the utilization time evaluation points. The display section displays the contents of the object policy and receives a positive or negative input for registering the object policy (S172). Then, the policy management section 15 determines if the input is positive or negative for registration and, if the input is negative (S173, N), ends the flow. If, on the other hand, the input is positive (S173, Y), the policy management section 15 registers the object policy as a new record in the case DB 21 (S174) and ends the flow. The project information read out section 13 acquires the business category and the dimension of the terminated project from the project information DB 22 and the policy management section 15 acquires the contents of the policy, the utilized step and the utilization time evaluation points of the object policy from the policy DB 23 and puts the contents of the policy, the business category, the dimension, the utilized step and the utilization time evaluation points in a new record.

With the above-described case registration process, it is possible to preserve the utilized policy in the case DB 21 and evaluate a policy similar to the policy.

Now, the user evaluation points updating process, which is the process in S13, will be described below.

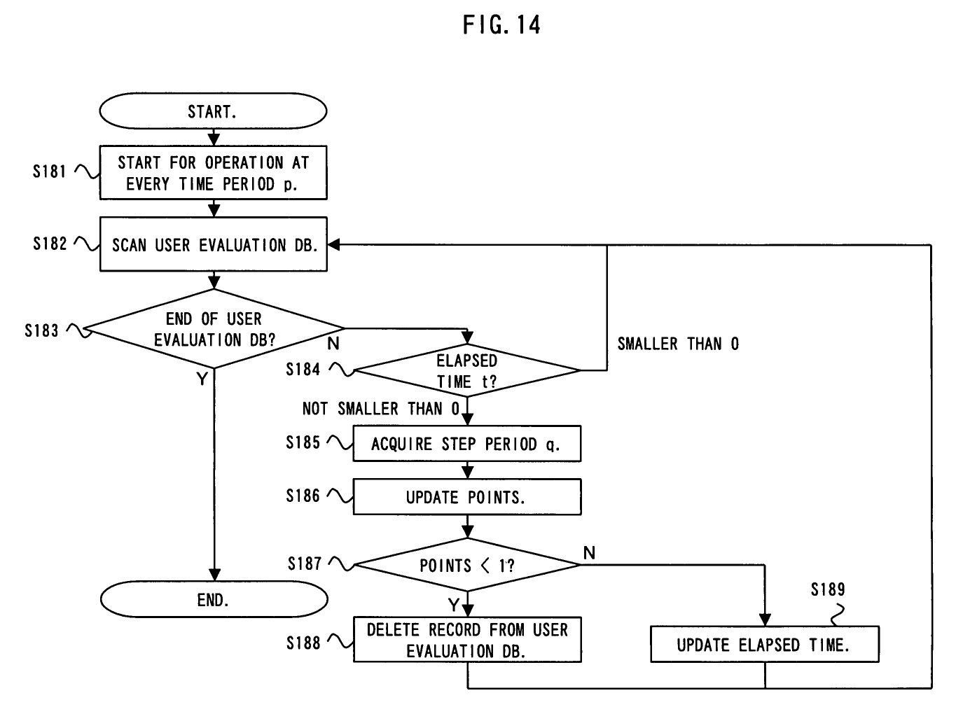

FIG. 14 is a flowchart of the user evaluation points updating process of this embodiment, showing a specific example thereof. Firstly, the directive section 17 starts the user evaluation management section 16 for operation at every predetermined period p (S181). Then, the user evaluation management section 16 scans the user evaluation DB 24 and sequentially acquires records to evaluate the object user (S182) and determines if it gets to the end of the user evaluation DB 24 or not. The user evaluation management section 16 ends the flow when it gets to the end of the user evaluation DB 24 (S183, Y), whereas it moves to the next process when it does not get to the end of the user evaluation DB 24 (S183, N).

Then, the user evaluation management section 16 determines if the elapsed time t of the object user evaluation is not less than 0 or not. The user evaluation management section 16 returns to the process of S182 if the elapsed time t is less than 0 (S184, less than 0), whereas it moves to the next process if the elapsed time t is not less than 0 (S184, not less than 0). Thereafter, the project information read out section 13 reads out the step period q of the object user evaluation step from the project information DB 22 (S185). Then, the user evaluation management section 16 updates the user evaluation points s of the object user evaluation by means of a user evaluation points updating formula that uses p, q, t, s (S186). The user evaluation points updating formula is typically expressed in a manner as shown below.

s=1−s×(p+t)/(2×q)

With the user evaluation points updating formula, the user evaluation points decreases as the elapsed time increases. The decrease of the user evaluation points is slow when the step period is long. Subsequently, the user evaluation management section 16 determines if the updated user evaluation points are smaller than 1 or not. The user evaluation management section 16 deletes the object user evaluation from the user evaluation DB 24 (S188) when the user evaluation points are smaller than 1 (S187, Y) and moves to the process of S182, whereas it adds p to the elapsed time of the object user evaluation to update the latter (S189) when the user evaluation points are not smaller than 1 (S187, N) and moves to the process of S182.

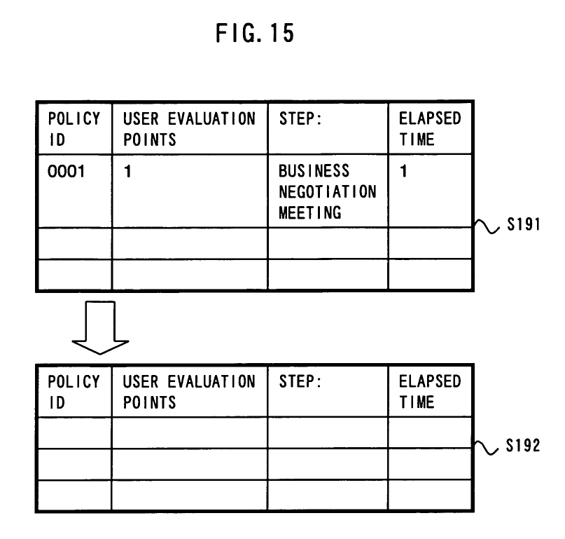

Now, the user evaluation points updating process will be described below by way of a specific example. FIG. 15 is an illustration of the chart to be used in the user evaluation points updating process of this embodiment, showing a specific example thereof. A record in the user evaluation DB 24 will be described below, assuming that the project period=12, the business negotiation period=2. As the user evaluation management section 16 acquires the object user evaluation in the user evaluation DB 24 (S191), it computationally determines the new user evaluation points by means of the above-described user evaluation points updating formula. The updated user evaluation points=1−1(0.6+1)/(2×2)=0.6, which is smaller than 1, so that the user evaluation management section 16 deletes the user evaluation record (S192) and ends the flow.

With the user evaluation points updating process, it is possible to raise the influence of a new user evaluation and reduce the influence of the corresponding old user evaluation by making the user evaluation points decrease with the elapsed time.

The policy registration step in the claims corresponds to the processes S111, S112 of the above-described embodiment. The first evaluation step in the claims corresponds to the process S113 of the above-described embodiment. The display step in the claims also corresponds to the processes S113 of the above-described embodiment. The case registration step in the claims corresponds to the processes S61, S71 of the above-described embodiment. The second evaluation step in the claims corresponds to the user evaluation totalizing process of the above-described embodiment. The evaluation registration step in the claims corresponds to the process S31 of the above-described embodiment. The evaluation updating step in the claims corresponds to the process S13 of the above-described embodiment.

The policy registration section in the claims corresponds to the policy management section of the above-described embodiment. The first evaluation section in the claims corresponds to the similar case search section of the above-described embodiment. The second evaluation section in the claims corresponds to the user evaluation management section of the above-described embodiment.

The policy management apparatus of this embodiment can be applied to an information processing apparatus without any difficulty to enhance the performance of the information processing apparatus. The information processing apparatus may be a server, a PC (personal computer) or some other apparatus.

Additionally, it is possible to provide a policy management program for causing the computer operating as a component of a policy management apparatus according to the present invention to execute the above-described steps. Such a program can be executed by the computer operating as a component of a policy management apparatus when the program is stored in a computer readable recording medium. Computer readable recording mediums that can be used for the purpose of the present invention include internal storage apparatus such as ROMs and RAMs mounted in computers, portable type storage mediums such as CD-ROMs, flexible disks, DVD disks, magneto-optical disks and IC cards, external computers, data bases of such computers and transmission mediums on communication lines.

What is claimed is:

1. A policy management program that causes a computer to manage the policies in a project by causing the computer to execute:
a policy registration step that registers policy information including the contents of policies;
a first evaluation step that acquires case information satisfying the predetermined first requirement from the case information including the contents of the utilized policies registered in advance and computationally determines an evaluation value for each of the policies registered in the policy registration step according to the case information; and
a display step that displays the policy information of the one or more than one policies showing an evaluation value satisfying the predetermined second requirement as computed in the first evaluation step.

2. The program according to claim 1, wherein
the case information includes the evaluation value of each of the utilized policies at the time of utilization thereof; and
the first evaluation step computationally determines the evaluation value of each of the policies registered in the policy registration step according to the evaluation values in the case information that satisfies the first requirement.

3. The program according to claim 1, wherein
the first requirement is that the case information is similar to the policy information registered in the policy registration step.

4. The program according to claim 1, wherein,
when case information that satisfies the first requirement relative to a policy registered in the policy registration step exists, the first evaluation step increases the evaluation value of the policy.

5. The program according to claim 1, wherein
the case information further includes information on the steps where the policies are utilized; and
the first evaluation step acquires information on the current step of the current project and, when case information that satisfies the first requirement relative to a policy registered in the policy registration step exists and the information on the steps in the case information agrees with the information on the current step, increases the evaluation value of the policy.

6. The program according to claim 5, wherein
the first evaluation step re-computes the evaluation value when the current step is switched.

7. The program according to claim 1, further causing the computer to execute:
a case registration step that registers the status of utilization of the utilized policies among the policies registered in the policy registration step as case information when the policies are utilized.

8. The program according to claim 1, wherein
the policy registration step presents a choice for inputting the policy information.

9. The program according to claim 8, wherein
the policy registration step acquires the choice from the case information.

10. The program according to claim 1, further causing the computer to execute:
a second evaluation step that acquires the user evaluation value of a policy given by the user and registered in advance, adds the user evaluation value to the evaluation value computationally determined in the first evaluation step and updates the evaluation value;
the display step being adapted to display policy information in which the evaluation value updated in the second evaluation step satisfies a predetermined second requirement.

11. The program according to claim 10, further causing the computer to execute:
an evaluation registration step that registers the user evaluation on each policy registered in the policy registration step as a user evaluation value for the policy.

12. The program according to claim 11, further causing the computer to execute:
an evaluation updating step that updates the user evaluation value according to the time since the time point when the evaluation registration step registered the user evaluation value.

13. The program according to claim 12, wherein
the evaluation updating step decreases the user evaluation value with the elapsed time since the time point when the evaluation registration step registered the user evaluation value.

14. The program according to claim 1, wherein
the second requirement is that the evaluation value of the policy is not lower than a predetermined threshold value.

15. The program according to claim 1, wherein
the display step displays the policies registered in the registration step and emphatically displays the policies having an evaluation value that satisfies a predetermined requirement.

16. A policy management apparatus for managing the policies in a project, the apparatus comprising:
a policy registration section that registers policy information including the content of policies;
a first evaluation section that acquires case information satisfying the predetermined first requirement from the case information including the contents of the utilized policies registered in advance and computationally determines an evaluation value for each of the policies registered by the policy registration section according to the case information; and
a display section that displays the policy information of the one or more than one policies showing an evaluation value satisfying the predetermined second requirement as computed by the first evaluation section.

17. The apparatus according to claim 16, wherein
the case information includes the evaluation value of each of the utilized policies at the time of utilization thereof; and
the first evaluation section computationally determines the evaluation value of each of the policies registered by the policy registration section according to the evaluation values in the case information that satisfies the first requirement.

18. The apparatus according to claim 16, wherein
the first requirement is that the case information is similar to the policy information registered by the policy registration section.

19. The apparatus according to claim 16, further comprising:
a second evaluation section that acquires the user evaluation value of a policy given by the user and registered in advance, adds the user evaluation value to the evaluation value computationally determined by the first evaluation section and updates the evaluation value;
the display section being adapted to display policy information in which the evaluation value updated by the second evaluation section satisfies a predetermined second requirement.

20. A policy management method for managing the policies in a project, the method comprising:
a policy registration step that registers policy information including the content of policies;
a first evaluation step that acquires case information satisfying the predetermined first requirement from the case information including the contents of the utilized policies registered in advance and computationally determines an evaluation value for each of the policies registered in the policy registration step according to the case information; and
a display step that displays the policy information of the one or more than one policies showing an evaluation value satisfying the predetermined second requirement as computed in the first evaluation step.
